(19) United States
(12) Patent Application Publication
(10) Pub. No.: US 2012/0014781 A1
(43) Pub. Date: Jan. 19, 2012

(54) MOUNTING APPARATUS AND FAN ASSEMBLY USING THE SAME

(75) Inventors: ZHENG-HENG SUN, Tu-Cheng (TW); XIAO-FENG MA, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (TW)

(21) Appl. No.: 12/848,196

(22) Filed: Aug. 1, 2010

(30) Foreign Application Priority Data
Jul. 13, 2010 (CN) 201010224783.3

(51) Int. Cl. F01D 15/00; F16M 13/00

(52) U.S. Cl. 415/121.3; 248/615

(57) ABSTRACT

A mounting apparatus includes a shockproof member and a fixing member. The shockproof member includes a first block plate and a sleeve extending from the first block plate. The sleeve defines a first through hole thereon extending through the first block plate. The fixing member includes a second block plate, a mounting post extending from the second block plate to extend through the first through hole, a pin, and a contact post. The mounting post includes two raised portions fixed on the mounting post. Each of the two raised portions defines a pin hole. The contact post defines a second through hole thereon. The contact post is pivotably secured to the mounting post by the pin running through the pin holes and the second through hole.

### BACKGROUND

1. Technical Field

The present disclosure relates to device mounting and, particularly, to a mounting apparatus for mounting a fan to a chassis of an electronic device.

2. Description of Related Art

Electronic devices typically generate heat during operation due to the flow of electricity through electronic components housed within the device. Electronic components may be damaged if this heat is not removed. Generally, an electronic device uses a fan to produce a flow of air for cooling the electronic components. Conventionally, a fan is mounted in the electronic device by a plurality of screws passing through corresponding holes of the fan, making it difficult and time consuming to replace or remove the fan for repair.

Therefore, a mounting apparatus is desired to overcome the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of a plurality of mounting apparatuses according to an exemplary embodiment applied with a fan and chassis.

FIG. 2 is an exploded, isometric view of FIG. 1.

FIG. 3 is an exploded, isometric view of a fixing member and a shockproof member of one of the mounting apparatuses of FIG. 1.

FIG. 4 is a partially assembled, isometric view of FIG. 3.

FIG. 5 is an enlarged view of encircled portion V of FIG. 1.

FIG. 6 is a cutaway view of FIG. 1.

### DETAILED DESCRIPTION

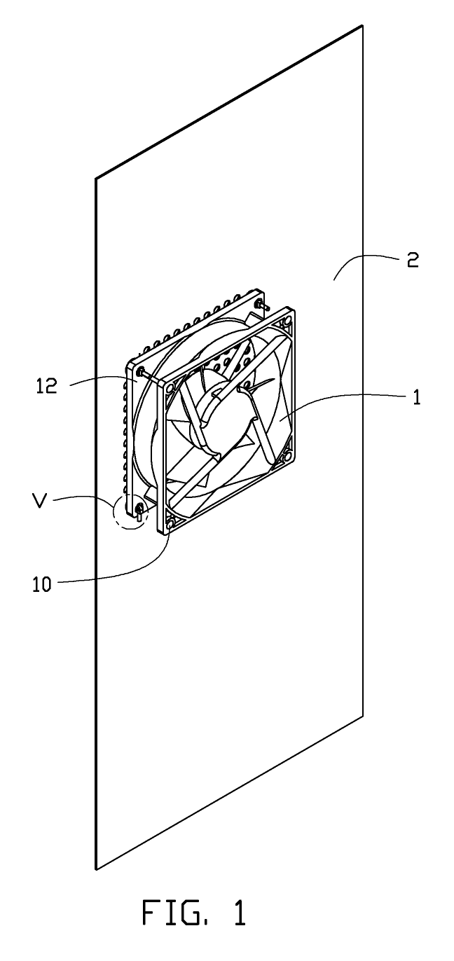

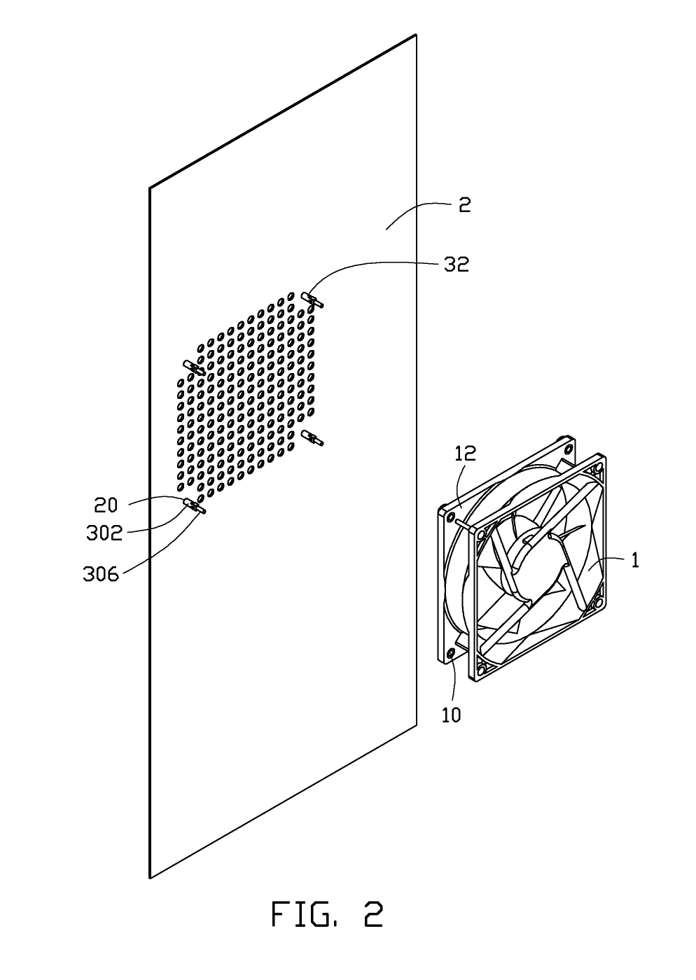

Referring to FIGS. 1-2, four mounting apparatuses according to an exemplary embodiment for mounting a fan 1 to a chassis 2 are shown. The fan 1 includes two rectangular end walls 12. Each of the two end walls 12 defines four first fixing holes 10 in four corners thereof respectively. The chassis 2 defines a grille area corresponding to the fan 1. The grille area defines four second fixing holes 20 in four corners thereof respectively.

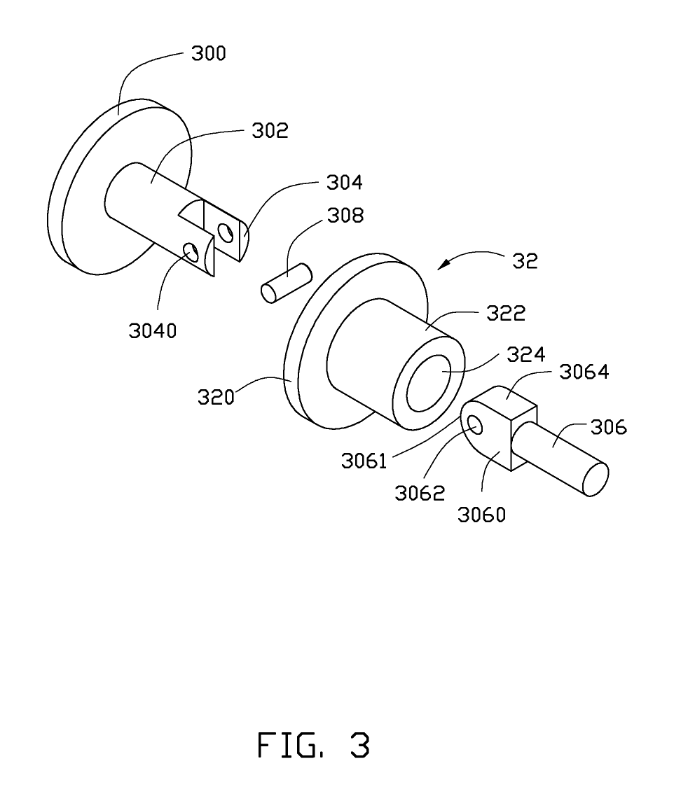

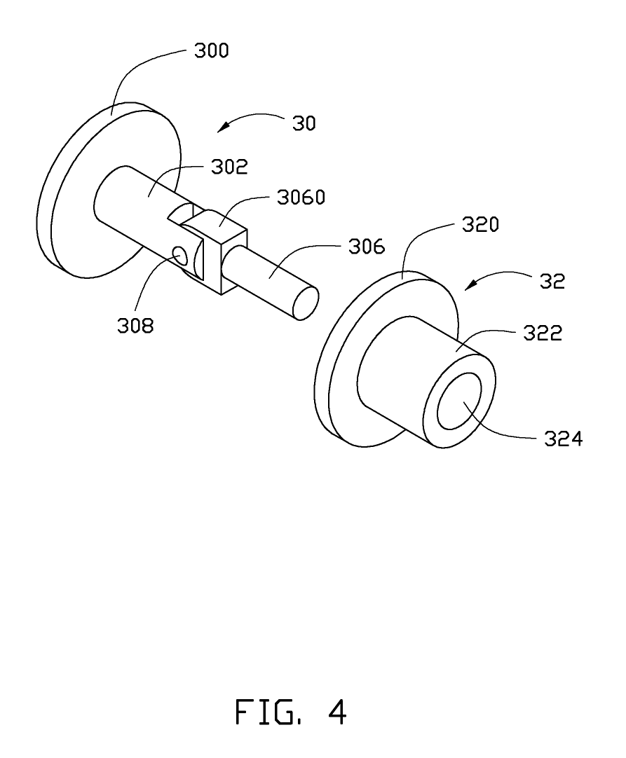

Referring to FIGS. 3-4, each mounting apparatus includes a shockproof member 32 and a fixing member 30.

The shockproof member 32 includes a first block plate 320 and a sleeve 322 extending from the first block plate 320. The first block plate 320 is circular. The sleeve 322 is cylindrical. A first through hole 324 is defined in the sleeve 322 and extends through the first block plate 320. The shockproof member 32 may be made of resilient material. In the illustrated embodiment, the resilient material may be rubber or silicone.

The fixing member 30 includes a second block plate 300, a mounting post 302 extending from the second block plate 300, a pin 308 and a contact post 306. The second block plate 300 is circular. The mounting post 302 is cylindrical. Two raised portions 304 are fixed on a distal end of the mounting post 302. The two raised portions 304 are separated by a distance. Each of the two raised portions 304 defines a pin hole 3040. The contact post 306 includes a pivot portion 3060 fixed thereon. A second through hole 3062 is defined in the pivot portion 3060. The second through hole 3062 corresponds to the pin holes 3040. The pivot portion 3060 includes an arcuate end surface 3061 formed on the pivot portion 3060 adjacent the mounting post 302. Two contact walls 3064 are formed on two ends of the arcuate end surface 3061. The two contact walls 3064 are parallel. A distance between a center of the second through hole 3062 and the arcuate end surface 3061 is less than that between the center of the second through hole 3062 and the contact wall 3064. The contact post 306 and the mounting post 302 can be pivotably secured to each other by the pin 308 running through the pin holes 3040 and the second through hole 3062.

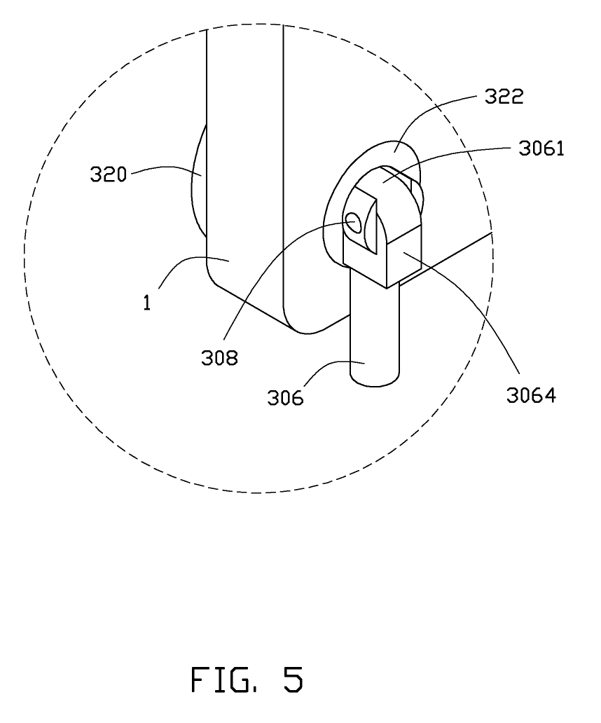

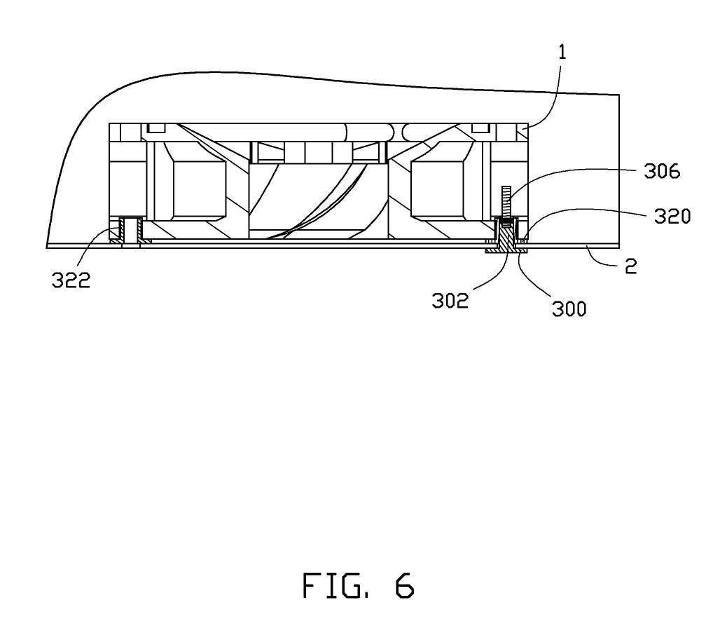

Referring to FIGS. 5-6, in assembly of the fan 1 to the chassis 2, the sleeve 322 of the shockproof member 32 is received in the first fixing hole 10 of the fan 1, and one end of the first block plate 320 of the shockproof member 32 abuts the end wall 12 of the fan 1. The other end of the first block plate 320 abuts the chassis 2, and the first through hole 324 of the shockproof member 32 is aligned with the second fixing hole 20 of the chassis 2. The fixing member 30 runs through the second fixing hole 20 and the first through hole 324 until the second block plate 300 of the fixing member 30 reaches the chassis 2. Because the distance between the center of the second through hole 3062 and the arcuate end surface 3061 is less than the distance between the center of the second through hole 3062 and the contact wall 3064, when the contact post 306 is rotated to a position substantially perpendicular to mounting post 302, one of the two contact walls 3064 abuts the end wall 12 of the fan 1, and the second block plate 300 of the mounting post 302 abuts the chassis 2. Accordingly, the fan 1 and the chassis 2 can be secured to each other.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A mounting apparatus comprising:
a shockproof member comprising a first block plate and a sleeve extending from the first block plate, wherein the sleeve defines a first through hole thereon extending through the first block plate; and
a fixing member comprising a second block plate, a mounting post extending from the second block plate to extend through the first through hole, a pin, and a contact post, wherein the mounting post comprises two raised portions fixed on a distal end thereof, wherein each of the two raised portions defines a pin hole, wherein the contact post comprises a pivot portion fixed thereon, wherein the pivot portion defines a second through hole thereon, wherein the contact post is pivotably secured to the mounting post by the pin running through the pin holes and the second through hole.

2. The mounting apparatus of claim 1, wherein the first block plate is circular; and wherein the sleeve is cylindrical.

3. The mounting apparatus of claim 1, wherein the shockproof member is made of resilient material.

4. The mounting apparatus of claim 3, wherein the resilient material is rubber or silicone.

5. The mounting apparatus of claim 1, wherein the second block plate is circular; and
wherein the mounting post is cylindrical.

6. The mounting apparatus of claim 1, wherein the pivot portion comprises an arcuate end surface and two contact walls, and wherein the arcuate end surface is formed on the pivot portion adjacent the mounting post, and wherein the two contact walls are formed on two ends of the arcuate end surface.

7. The mounting apparatus of claim 6, wherein a distance between a center of the second through hole and the arcuate end surface is less than a distance between the center of the second through hole and each contact wall.

8. A fan assembly, comprising:
a fan defining a plurality of first fixing holes in a wall of the fan respectively;
a chassis defining a plurality second fixing holes, corresponding to the plurality of first fixing holes, on a periphery of a grille area of the chassis respectively; and
a plurality of mounting apparatuses each for mounting the fan to the chassis and comprising:
a shockproof member comprising a first block plate and a sleeve extending from the first block plate, wherein the sleeve is received in one of the plurality of first fixing holes and defines a first through hole thereon extending through the first block plate; and
a fixing member comprising a second block plate, a mounting post extending from the second block plate, a pin, and a contact post, wherein the mounting post comprises two raised portions fixed on a distal end of the mounting post, wherein each of the two raised portions defines a pin hole, wherein the contact post comprises a pivot portion fixed thereon, wherein the pivot portion defines a second through hole thereon, wherein the contact post is pivotably secured to the mounting post by the pin running through the pin hole and the second through hole, wherein the fan is secured to the chassis by the fixing member passing through one of the plurality of second fixing holes, the corresponding one of the first fixing holes and the first through hole as the contact post is rotated to a position substantially perpendicular to the mounting post.

9. The mounting apparatus of claim 8, wherein the first block plate is circular; and wherein the sleeve is cylindrical.

10. The mounting apparatus of claim 8, wherein the shockproof member is made of resilient material.

11. The mounting apparatus of claim 10, wherein the resilient material is rubber or silicone.

12. The mounting apparatus of claim 8, wherein the second block plate is circular; and wherein the mounting post is cylindrical.

13. The mounting apparatus of claim 8, wherein the pivot portion comprises an arcuate end surface and two contact walls, and wherein the arcuate end surface is formed on the pivot portion adjacent the mounting post, and wherein the two contact walls are formed on two ends of the arcuate end surface.

14. The mounting apparatus of claim 13, wherein a distance between a center of the second through hole and the arcuate end surface is less than a distance between the center of the second through hole and each contact wall.
